(19) United States
(12) Patent Application Publication
(10) Pub. No.: US 2013/0263649 A1
(43) Pub. Date: Oct. 10, 2013

(54) VALVE, DEVICE COMPRISING A VALVE, USE OF THE VALVE IN THE DEVICE, MICROPUMP COMPRISING A VALVE, ATOMIZATION SYSTEM COMPRISING A VALVE, AND METERING/MIXING DEVICE COMPRISING A VALVE

(71) Applicants: Reinhold Storch, Munchen (DE); Martin Lang, Wessobrunn (DE); Joseph Lass, Munchen (DE)

(72) Inventors: Reinhold Storch, Munchen (DE); Martin Lang, Wessobrunn (DE); Joseph Lass, Munchen (DE)

(73) Assignee: PARItec GmbH, Starnberg (DE)

(21) Appl. No.: 13/878,869

(22) PCT Filed: Oct. 7, 2011
(86) PCT No.: PCT/EP2011/067561

§ 371 Date: Jun. 17, 2013

(30) Foreign Application Priority Data
Oct. 11, 2010 (DE) 10 2010 042 265.7

(51) Int. Cl. F16K 11/10

(52) U.S. Cl. CPC F16K 11/10
USPC 73/53.01; 251/366; 137/625; 251/304; 251/318; 251/206; 137/565.01; 137/561 R

(57) ABSTRACT

The invention relates to a valve (10, 40, 60, 80, 100, 120, 150, 210), comprising a first valve element (12, 42, 62, 82, 102, 122, 152, 212) and a second valve element (14, 44, 64, 84, 104, 124, 154, 214), wherein the first valve element comprises a first carrier part (13, 43, 63, 83, 103, 123, 153, 213) which is made of plastic material and a first surface element (16, 46, 66, 86, 106, 126, 158) which is made of silicon or silicon oxide and is fastened to the first carrier part, and the second valve element comprises a second carrier part (15, 45, 65, 85, 105, 125, 155, 215) made of plastic material and a second surface element (18, 47, 67, 87, 107, 127, 159, 218) which is made of silicon or silicon oxide and is fastened to the second carrier part. The valve elements are arranged such that the first and second surface elements are seated in a planar manner against each other at least partially along an abutment surface, wherein the valve elements can be moved relative to each other in at least one direction parallel to the abutment surface of the surface elements. The first surface element has at least one first opening (20, 20′, 50, 70, 70′, 90, 90′, 110, 130, 130′, 162) and the second surface element has at least one second opening (22, 22′, 52, 52′, 52″, 72, 72′, 92, 92′, 112, 112′, 132, 132′, 163, 222), wherein the valve elements can be moved relative to each other in the at least one direction parallel to the abutment surface in at least one first position, in which the at least one first opening and the at least one second opening are in fluid connection with each other, and at least one second position, in which the at least one first opening and the at least one second opening are not in fluid connection with each other. The invention further relates to a device (200) comprising such a valve, to a use of the valve in a device, and to a micropump (400, 900), a nebulizer system (700) and a dosing/mixing device (500) comprising such a valve.

The invention relates to a valve having at least two valve elements which are movable relative to one another, to a device comprising such a valve, to a use of such a valve in a device, to a micropump comprising such a valve, to an atomization system comprising such a valve, and to a metering/mixing device comprising such a valve.

The invention can be used for various fields with fluid applications, such as switching, regulation, analysis, diagnosis, therapy, measurement, transport, mixing, cleaning, metering and the like. A large number of fields of application in industry and research are conceivable, such as pharmaceutical, medical, measuring, analytical, diagnostic, laboratory, fluid and microfluid technology.

Rotary and sliding valves having two valve components, in which the valve can be opened or closed by rotating or sliding the two components relative to one another, are known in the art. In order to ensure a tight fluidic connection between the components, sealing elements of silicon, Teflon or rubber are used in such valves. However, those elements are frequently damaged if the valve is operated improperly. Moreover, such elements are subject to a high degree of wear, which results in a shortened working life of the valve. In order to achieve a tight fluidic connection between the valve components without additional sealing elements even when the valve is subject to high stress, the connecting surfaces between the components must exhibit a very high degree of evenness, low roughness and high wear resistance.

DE 103 14 387 discloses a valve for microtechnology for opening and closing microchannels. The valve comprises a closure plate and a valve plate, which is provided with an inlet and an outlet. The inlet and the outlet can be connected to one another by way of a channel formed in the closure plate. The closure plate is slidably mounted on the valve plate. Both the valve plate and the closure plate are manufactured from silicon and are additionally polished.

U.S. Pat. No. 4,647,013 discloses a silicon return valve for controlling the flow of a fluid using a first and a second silicon element. The first silicon element is substantially planar and has an orifice for passage of the fluid. The second silicon element has a planar silicon surface, which can be moved relative to the orifice in order thus to open or close the orifice for controlling the flow of fluid. The two silicon elements are pressed against one another by a spring.

Moreover, there is known from DE 36 33 483 a control-disk valve which comprises a housing having a first fixed control disk, which has at least one inlet opening for the liquid to be controlled, and a second control disk, which is displaceable in a linear manner relative to the first control disk and has at least one regulating recess which cooperates with the inlet opening(s) of the fixed control disk. The second control disk is composed of a lower ceramics disk and an upper carrier part made of plastics material. The ceramics disk and the carrier part together delimit a guide channel which serves as a regulating recess and by way of which, depending on the relative position of the two control disks, water is able to flow from the inlet openings to an outlet opening of the fixed control disk.

The object underlying the invention is to provide a wear-resistant valve which can be produced inexpensively, as well as a device, a micropump, an atomization system and a metering/mixing device which use such a valve, and a use of such a valve in a device.

The object is achieved by a valve having the features of claim 1, a device having the features of claim 13, a use having the features of claim 15, a micropump having the features of claim 16, an atomization system having the features of claim 19, and a metering/mixing device having the features of claim 20. Advantageous embodiments follow from the other claims.

The valve according to the invention comprises a first valve element and a second valve element, wherein the first valve element comprises a first carrier part of plastics material and a first planar element of silicon or silicon oxide (glass, SiO₂) which is fastened to the first carrier part, and the second valve element comprises a second carrier part of plastics material and a second planar element of silicon or silicon oxide (glass, SiO₂) which is fastened to the second carrier part. The valve elements are so arranged that the first and the second planar element abut one another at least partially in a planar manner along an abutment surface, wherein the valve elements are movable relative to one another in at least one direction parallel to the abutment surface of the planar elements. The first planar element has at least one first opening and the second planar element has at least one second opening. The valve elements are movable relative to one another in the at least one direction parallel to the abutment surface into at least one first (open) position, in which the at least one first opening and the at least one second opening are in fluid connection with one another, and at least one second (closed) position, in which the at least one first opening and the at least one second opening are not in fluid connection with one another.

Preferably, the valve is open when the at least one first opening and the at least one second opening are in fluid connection with one another, and the valve is closed when the at least one first opening and the at least one second opening are not in fluid connection with one another.

The movability of the valve elements relative to one another in at least one direction parallel to the abutment surface of the planar elements is so defined that the valve elements are able to move to and fro in that direction (translationally and/or rotationally), that is to say in the positive and negative vectorial direction. In that manner, the valve elements can be brought in a reversible manner into at least two different positions relative to one another, namely a first (open) position, in which the valve is open, and a second (closed) position, in which the valve is closed.

Preferably, the two valve elements are pressed against one another by application of a defined external force in a direction perpendicular to the abutment surface between the planar elements, in order thus to increase further the fluidic tightness (closeness) at the abutment surface. Because silicon and silicon oxide are materials with low surface roughness and high evenness, a fluidically tight connection between the two valve elements can be achieved even with low external forces. In addition, there is low friction, in particular low sliding friction, at an abutment surface between such materials, so that high forces are not required to switch the valve. Furthermore, such a reduction of the frictional forces also reduces the wear of the valve elements. Silicon and silicon oxide are, moreover, wear-resistant materials which also withstand high mechanical stress (e.g. friction), have high chemical, biological, medical and/or pharmaceutical stability, and are corrosion-resistant and biocompatible. It is thus possible to provide a smooth-running valve which has a long working life and which in particular is very suitable for use in a device for the analysis (measurement) of liquids because, inter alia, contamination of the liquid to be measured is reliably prevented by the high stability of the planar elements.

Silicon and silicon oxide have very low roughness and high evenness even in the unmachined, unprocessed state, for example in wafer form, and can accordingly be used in the valve according to the invention without further machining, which results in a considerable reduction in the production costs. However, it is also possible to polish the surface of at least one of the planar elements in order thus to increase its (or their) evenness further. Preferably, monocrystalline silicon is used as the material for the first and/or the second planar element.

Because in the valve according to the invention only part of each of the valve elements consists of silicon or silicon oxide and the valve elements are otherwise composed of a plastics carrier part, the material costs can be lowered considerably compared with a valve in which the valve elements are produced wholly from silicon or silicon oxide. In addition, such a construction enables fluid channel structures to be formed simply and precisely in the valve elements, as will be described in detail below, as a result of which the production costs can also be lowered. Moreover, repair and maintenance costs are lower owing to the simple construction of the valve according to the invention.

In the valve according to the invention, one of the valve elements can be fixed and the other valve element can be arranged to be movable relative thereto. However, depending on the field of use of the valve, both valve elements can also be designed to be movable relative to one another. The relative movement of the valve elements to one another is preferably effected by an actuator, such as, for example, manually with a mechanical movement, an electric motor with or without enhancement of the mechanical movement (lever arm or gear), an electrostatic actuator, a piezo element, a magnetic linear actuator, a magnetic actuator, a pneumatic actuator or the like. In that manner, the valve switching operation can be controlled, regulated and automated in a simple manner, for example by a corresponding circuit.

Preferably, the valve according to the invention is in the form of a multiway valve, in which the first planar element has a plurality of first openings and/or the second planar element has a plurality of second openings, wherein the valve elements are movable relative to one another in the at least one direction parallel to the abutment surface into a plurality of different first (open) positions, in each of which at least one of the first openings is in fluid connection with at least one of the second openings. The valve element can have one or more second (closed) positions, in which there is no fluid connection between the first and the second opening.

If the first planar element has a plurality of first openings and the second planar element has a plurality of second openings, a plurality of the first openings can each be in fluid connection with one of the second openings in one or more of the different first positions. In that manner, the valve has a plurality of open positions in which the flow of a fluid through the valve is possible, it being possible for the flows of fluid each to pass by way of different openings in the planar elements.

Such a construction permits precise control of the flow of fluid by way of a plurality of different flow paths and accordingly a broad field of use for the valve. In particular, especially precise switching of the valve is made possible in this case by the low valve actuating forces that are necessary because of the low frictional forces that occur at the abutment surface.

Furthermore, machining processes known in silicon technology allow the openings (or recesses, such as, for example, a groove without a covering) in the planar elements to be formed in a well-defined manner with small dimensions and close to one another, that is to say with small intervals between them. The dimensions of the valve can accordingly be reduced, as a result of which the valve is highly suitable in particular for use in microfluidic components or devices, such as, for example, in micropumps or in the MEMS field. The valve can preferably be used in measuring technology, analytical technology, medical technology (such as atomization systems and implant technology).

Such a multiway valve according to the invention can be used particularly advantageously in a device for measuring the properties of or for analyzing a fluid (liquid, gas), in particular in order to permit the transport of different fluids, such as, for example, the liquid to be measured, a calibration liquid, a carrier liquid, a marker, a cleaning liquid and/or a rinsing liquid, etc. Depending on the fluid to be transported, the valve can in this case be switched between the plurality of different first positions. Preferably, the first carrier part has at least one fluid channel which is in fluid connection with one or more of the first openings, and/or the second carrier part has at least one fluid channel which is in fluid connection with one or more of the second openings. It is also possible to provide a plurality of fluid channels in both the first carrier part and the second carrier part. The fluid channels can in each case connect two or more first openings or two or more second openings with one another or can permit a fluid connection of a first opening or of a second opening with the outside of the corresponding valve element. In that manner, the valve can be adapted in a simple manner to the desired use, for example in a device for liquids that are to be measured or analyzed.

The fluid channels can be formed in the planar element of silicon or silicon oxide or in particular, in a simple and precise manner, in the carrier parts of plastics material, because plastics material is considerably easier to machine than silicon or silicon oxide. For example, the channels can be formed in the carrier parts during the production of the carrier parts, for example by providing suitable mold inserts in an injection molding or compression molding process, as a result of which the production of the valve is simplified considerably and the production costs are reduced. In addition, the fluid channels can also be provided subsequently, for example by a milling, drilling, turning, punching, laser, etching, machining or cutting process.

In an advantageous embodiment of the valve according to the invention, the first planar element has two first openings which are in fluid connection with one another by way of a fluid channel in the first carrier part. By means of such a construction, it is possible, for example, in a simple form, to bring a fluid inlet of the second valve element into fluid connection with a fluid outlet of the second valve element by moving the valve elements relative to one another so that one of the first openings comes into fluid connection with the fluid outlet and the other of the first openings comes into fluid connection with the fluid inlet of the second valve element. Preferably, such a fluid channel can be in the form of a recess which is covered completely by the first planar element, wherein the two first openings are in fluid connection with one another by way of the recess. Such a recess can be formed in a simple manner during the production of the carrier part by means of a suitable mold or a suitable mold insert, for example in an injection molding, compression molding, shaping, blowing, stamping, deep drawing or vacuum forming process, and accordingly enables the valve to be produced in a particularly simple and inexpensive manner. When the valve according to the invention is used as a multiway valve, it is also possible to provide more than two openings, for example at different intervals from one another, in the first planar element.

With such a construction of the first planar element, the second planar element can in particular have three second openings, wherein the valve elements are movable relative to one another in the at least one direction parallel to the abutment surface into at least two different first positions, in each of which two of the three second openings are in fluid connection with one another by way of the fluid channel in the first carrier part. In that manner, for example, two different fluid inlets of the second valve element, depending on the position of the valve elements, can be brought into fluid connection with a fluid outlet of the second valve element, or a fluid inlet of the second valve element, depending on the position of the valve elements relative to one another, can be brought into fluid connection with two different fluid outlets of the second valve element. Such a construction is advantageous, for example, when the valve is used as a multiway valve in a device for liquids, in particular when a plurality of different liquids, such as, for example, the liquid to be measured, a calibration liquid and/or a rinsing liquid, have to be transported through the valve. The construction of the multiway valve can likewise have a plurality of positions in which there is or is not a fluid connection. To that end, for example, two of the four, three of the four or three of the five or more second openings can be in fluid connection with one another by way of the fluid channel in the first carrier part.

In a further advantageous embodiment of the valve according to the invention, the first planar element has three first openings, wherein two of those openings are in fluid connection with one another by way of a fluid channel in the first carrier part and the third of those openings is in fluid connection with the outside of the first valve element by way of a fluid channel in the first carrier part. In that manner, for example, a fluid, such as, for example, a calibration, carrier, buffer, indicator, marker, cleaning liquid and/or rinsing liquid for a device, or further fluids necessary for the process/device, can be supplied or discharged by way of the first valve element.

In a further advantageous embodiment of the valve according to the invention, the valve comprises a third valve element, wherein the third valve element comprises a third carrier part of plastics material and a third planar element of silicon or silicon oxide (glass, SiO₂) which is fastened to the third carrier part. The second valve element in this case comprises two second planar elements of silicon or silicon oxide (glass, SiO₂) which are fastened to the second carrier part. The first to third valve elements are so arranged that the first and one of the second planar elements abut one another at least partially in a planar manner along a first abutment surface, and the third and the other of the second planar elements abut one another at least partially in a planar manner along a second abutment surface which is parallel to the first abutment surface, wherein the second valve element is movable relative to the first and the third valve element in at least one direction parallel to the abutment surfaces of the planar elements. The third planar element has at least one third opening, wherein the second valve element is movable relative to the first and third valve elements in the at least one direction parallel to the abutment surfaces into at least one first position, in which the at least one first opening and the at least one third opening are in fluid connection with one another by way of the at least one second opening, and at least one second position, in which the at least one first opening and the at least one third opening are not in fluid connection with one another.

The movability of the second valve element in at least one direction parallel to the abutment surfaces of the planar elements is so defined that the second valve element is able to move to and fro in that direction, that is to say in the positive and negative vectorial direction. Preferably, the valve is open when the at least one first opening and the at least one third opening are in fluid connection with one another by way of the at least one second opening, and closed when the at least one first opening and the at least one third opening are not in fluid connection with one another.

Preferably, the first valve element and the third valve element are fixed and the second valve element is arranged to be movable relative to the first and the third valve element. However, it is also possible for two or all of the first to third valve elements to be movable.

In order to achieve a particularly tight fluidic connection between the abutment surfaces, an external force is preferably applied to the valve elements in a direction perpendicular to the abutment surfaces. Moreover, the first to third valve elements can each have a plurality of openings in order thus to permit a plurality of first (open) positions with different fluid connections or fluid flow paths. Connections, channels or complete recesses, such as depressions, can be formed.

The fastening of the planar elements to the carrier parts can be carried out by any desired process which permits adequate strength and stability of the connection between the carrier part and the planar element. For example, additional fastening elements, such as, for example, clamps, clips, screws, hot stamping, pressing, application/spreading/positioning/tightening (groove and pin) or the like, can also be used for the fixed connection between the carrier part and the planar element. Preferably, however, the valve elements are produced in the following manner. The plastics part is first formed, with a desired fluid channel structure, by injection molding, compression molding, machining by milling or the like. In order to produce the planar elements, a silicon or silicon oxide wafer is structured, that is to say provided with the desired openings, for example by lithography (optical lithography, electron beam lithography, etc.) and dry- or wet-chemical etching (or by means of ASE “Advanced Silicon Etch” processes or diamond machining) and then cut. The silicon sheets can be structured and cut, for example, by means of laser-assisted cutting processes. The planar elements provided with the openings are then preferably adhesively bonded to the carrier parts, stamped into them, or enclosed as an insert in injection molding. A particularly stable connection between the carrier part and the planar element can be achieved in a simple manner by hot stamping. In that process, a carrier part consisting at least partially of a thermoplastic plastic, such as, for example, polycarbonate (PC), polymethyl methacrylate (PMMA), polyvinyl chloride (PVC), polyoxymethylene (POM), cycloolefin copolymers (COC), polyphenylene sulfide (PPS), polyether sulfone (PES), polyether imide (PEI) and polyether ketone (PEEK), is used, the planar element is brought into contact with the carrier part, and the thermoplastic material of the carrier part is then heated, at least in the area surrounding the planar element, to a temperature above the softening temperature of the thermoplastic material. By displacing the heated thermoplastic material, for example by exerting an external force on the planar element, an at least partially interlocking and/or force-based connection between the planar element and the carrier part is achieved, which, after cooling of the thermoplastic material to a temperature below its softening temperature, exhibits a particularly high degree of strength. Such a heat stamping process for connecting two components is disclosed in DE 10 2008 027 026.

The valve according to the invention can be in the form of a rotary valve, in which the valve elements are movable relative to one another by rotation of one valve element relative to the other valve element or elements about an axis perpendicular to the abutment surface. Such a construction permits particularly short switching times between the possible positions of the valve. The construction of the valve according to the invention as a rotary valve is advantageous in particular with regard to the choice of actuator, because a large number of different actuators can be used in that case, such as, for example, electric motors or magnetic actuators.

Alternatively, the valve according to the invention can also be in the form of a sliding valve (slide valve), in which the valve elements are movable relative to one another by a parallel displacement, that is to say a linear displacement in one direction, of one valve element relative to the other valve element or elements. Moreover, a valve construction is also possible in which the valve elements are movable relative to one another both by a rotation as defined above and by a parallel displacement as defined above.

In an advantageous embodiment of the valve according to the invention, the first and/or the second planar element has a plurality of openings with different opening cross-sections so that, depending on the arrangement of the planar elements relative to one another, a flow of fluid through the valve can be adjusted by way of those different opening cross-sections. One form of implementation may be an adjustable valve which regulates (meters) the amount of fluid conveyed by means of flow openings (valve openings), the channel length (groove length) or channel cross-sections (groove cross-sections). This can be achieved, for example, by way of different valve opening sizes or different gap sizes.

In a further advantageous embodiment of the valve according to the invention, the valve further comprises an actuator for moving the valve elements relative to one another, wherein the actuator is preferably so constructed that it can be uncoupled from the remaining part of the valve. The actuator can be integrated into a re-usable device unit. Accordingly, the valve components that come into contact with a conveying medium (e.g. a fluid) can be positioned in a disposable unit, and the actuator can be used repeatedly with the remainder of the device as a whole.

Owing to the simple construction and the possible small dimensions of the valve according to the invention, the valve can be combined in a simple manner with other fluidic or microfluidic structures or components, such as, for example, filters, mixers, metering devices, pumps, reservoirs, membranes, nebulizers, atomizers, endoscopes, working channels, other valves and the like. Moreover, by the provision of corresponding additional elements, the valve can also be so designed that it fulfils further functions in addition to control of the transport of a fluid, such as, for example, the function of a filter and/or mixer. For example, a filter element or a plurality of filter elements could be provided in one or more of the first and/or second openings and/or in one or more of the fluid channels. When using the valve in a device for liquids, the valve could accordingly filter impurities out of the liquid that is to be controlled prior to use, in order to prevent the device from being damaged and its use (e.g. measurement, analysis, diagnosis, therapy) from being impaired.

The invention further provides a device for measuring (analyzing) the properties of a fluid (liquid, gas), such as, for example, chemical/biological substances, medicaments, foodstuffs (drinks or food), ingredients, industrial fluids, compositions, adhesives or the like, wherein the device comprises a valve according to the invention as described above for controlling the transport of the fluid in the device. The fluids used can especially be body fluids, such as, for example, blood, saliva, urine, semen, inflammatory body fluid (pus), lung secretions, mucus, spinal fluid, ocular fluid (tears), bile, gastric acid or the like. Particularly advantageously, the valve according to the invention can be used in a blood glucose meter. The wear resistance, the low actuating forces and the low external force required in the direction perpendicular to the abutment surface permit precise transport of the liquid and accordingly accurate measurement as well as a long working life of the device.

Preferably, the device according to the invention comprises a multiway valve according to the invention, wherein the device is so configured that, with the valve elements arranged in one of the plurality of first positions, a calibration fluid (a calibration liquid) for calibrating the device can be transported through the valve and, with the valve elements arranged in another of the plurality of first positions, the fluid (or body fluid) can be transported through the valve for measurement of the properties of the fluid (or body fluid) in the device. The valve according to the invention permits rapid and precise switching between the different positions. Moreover, the multiway valve can also be so constructed that it has a plurality of different first (open) positions for the transport of different calibration fluids and/or different rinsing fluids and/or analysis fluids. The device can be so configured that the calibration is carried out automatically before measurement of the fluid (or body fluid). The valve according to the invention can also be used in a similar manner in a blood analysis system, preferably in the form of a sliding valve.

The invention further provides a use of the above-described valve according to the invention in the above-described device according to the invention for measuring the properties of a fluid (or body fluid), wherein the use comprises the following steps: displacement of the valve elements of the valve relative to one another in the at least one direction parallel to the abutment surface into one of the plurality of first (open) positions; transport of a calibration fluid (or calibration liquid) through the valve in order to calibrate the device while the valve elements are arranged in the one first position; movement of the valve elements of the valve relative to one another in the at least one direction parallel to the abutment surface into another of the plurality of first (open) positions, and transport of the fluid (or body fluid) through the valve in order to measure the properties of the fluid (or body fluid) in the device while the valve elements are arranged in the other first position. In that manner, the advantages already described above can be achieved.

The invention additionally provides a micropump for pumping a fluid, which micropump comprises a valve according to the invention as described above for controlling the transport of the fluid in the micropump. As has already been described above, the valve according to the invention is particularly suitable in particular for microfluidic applications, because the construction of the valve elements from a plastics carrier part and a silicon or silicon oxide planar element permits simple and accurate machining of the components and accordingly a precise formation of openings, apertures, passages, fluid channel structures and the like, even with a greatly reduced size of the valve. When used in such a micropump, the valve according to the invention is preferably in the form of a rotary valve in order thus to permit particularly short switching times. The valve according to the invention can be used in a similar manner also in an implanted metering device, such as, for example, insulin pumps.

Preferably, the micropump is so configured that its pumping direction can be reversed by moving the valve elements of the valve relative to one another in the at least one direction parallel to the abutment surface from one of the plurality of first positions into another of the plurality of first positions. In that manner, the pumping direction can be reversed simply and quickly. This function of reversing the pumping direction can be achieved, for example, by means of a 4/2-way valve.

The micropump can be so constructed that the valve directly controls the transport of the fluid at the inlet and outlet of a pump chamber of the micropump.

In a further preferred embodiment, the one-way valves of a micropump are replaced with the above-described valves according to the invention (rotary valve or sliding valve). By clever control of the pump and of the valve, on the one hand pumping can be carried out in different directions, and on the other hand different fluid substances can be combined (mixed) in the pump chamber and subsequently transported to the outside. Preferably, when used with a coupled micropump, the valve according to the invention is in the form of a rotary valve in order thus to permit particularly short switching times.

In a particularly preferred embodiment, accurately metered portions of the fluid (or of the liquid or liquids) are provided by means of the valve according to the invention and transported by means of a micropump. For this portioning of a fluid, it is possible to use on the one hand precise control of the valve in the switching operations or on the other hand the volume of the valve channels between the planar elements in the valve construction. If, for example, a valve channel loop is filled with a marker and the valve is subsequently switched to a supplied carrier medium, very precise volumes of the marker can be transported from the valve. The valve according to the invention can be used in a similar manner also in an endoscopy system for the metering of precise small volumes of a fluid, such as a cancer marker, preferably in the detection of cancerous growths or ulcers in the intestine, stomach or abdomen. A further preferred use of the valve according to the invention is precise fluid application in minimally invasive surgery (MIS), such as, for example, laparoscopy.

The invention additionally provides an atomization system for generating an aerosol, comprising a valve according to the invention for controlling the transport of a fluid in the atomization system.

Preferably, the atomization system has a micropump for pumping a fluid, which micropump comprises a valve according to the invention as described above for controlling the transport of the fluid (or liquids) by means of the micropump. As has already been described above, the valve according to the invention is particularly suitable in particular for fluidic applications, because the construction of the valve elements from plastics carrier parts and silicon or silicon oxide planar elements permits simple and accurate machining of the components. In the case of aerosol therapy in particular, this represents an inexpensive and small mobile application possibility. The atomization system can be, for example, an ultrasonic atomizer, an oscillating-membrane atomizer, a nozzle atomizer, a metered-dose inhaler with propellants (MDI or pMDI), or a modified dry powder inhaler (DPI or pDPI) with cleaning function. The devices can be non-breath-operated, breath-activated, or breathing maneuver setting. The possible applications are broadened in particular by the accuracy of metering (amount of fluid) and the possibility of a freely determinable active ingredient combination with a subsequent cleaning cycle when the valve according to the invention is used in an atomization system. The valve can supply the various fluids in succession directly to an atomization system, such as, for example, the membrane of an oscillating-membrane atomizer, or fill an optional intermediate reservoir. Different medicaments and cleaning fluids (gases or liquids), for example, can thereby be transported and atomized in succession, or different medicaments in different mixtures can be made available in a reservoir for atomization.

The operation of switching the valve into the different positions can be controlled both electronically and mechanically. Electronic control (logic unit) can control the atomization system (such as, for example, ultrasonic atomizer, oscillating-membrane atomizer, nozzle atomizer) and the valve in a coordinated manner. For example, a medicament 1, a medicament 2 and a cleaning liquid can be transported and/or atomized in succession or simultaneously. Likewise, mechanical control of the valve is possible for transporting and/or atomizing the different fluids. This mechanical valve control can be achieved by means of buttons (or switches or levers). However, a combination with an atomization component that is to be moved, such as a protective cap, a mouthpiece, a reservoir cover, a reservoir attachment (ampoule, blister, vial, jar), or with atomizer components (such as housing halves) is particularly advantageous. Different mechanical movements of the atomization system can be used for the positioning of the valve, such as screwing on, closing, turning, pushing, sliding, pressing, lifting and/or the like. For example, on removal of the protective cap (position 1), the valve can be so positioned that the reservoir is filled with the desired medicament (or medicaments). When the protective cap is first fitted (position 2), the valve is so positioned that a cleaning cycle (e.g. with cleaning liquid) is carried out. When the protective cap is fitted completely (position 3), the valve is closed and the atomization system is secured (closed).

The invention further provides a metering/mixing device for metering and/or mixing a defined volume of fluid, which metering/mixing device comprises a valve according to the invention for controlling the transport of a fluid in the metering/mixing device.

The invention will be described purely by way of example below with reference to the accompanying figures, in which

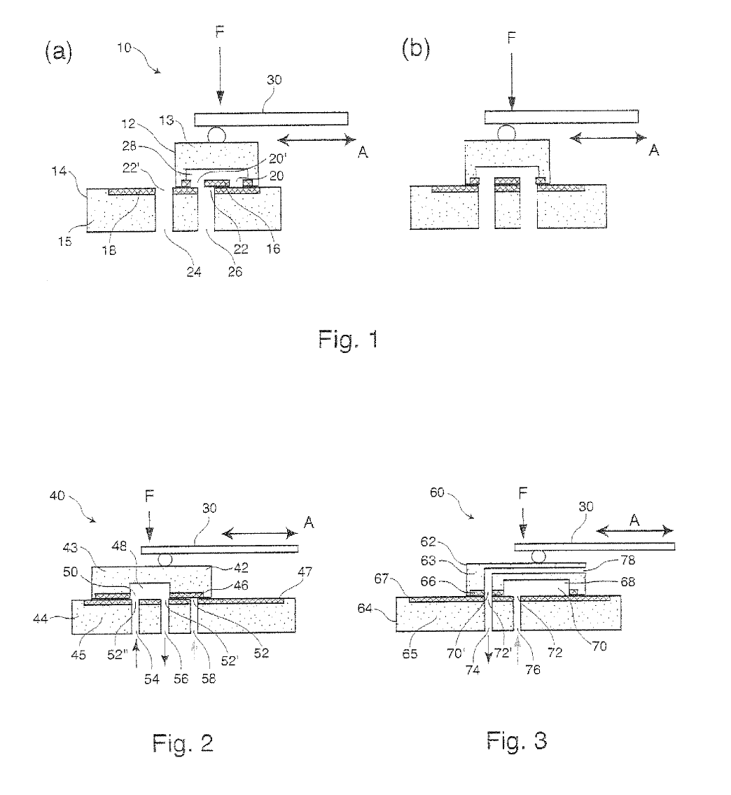

FIGS. 1a and 1b are schematic sectional representations perpendicular to the abutment surface showing the valve according to the invention in a first embodiment;

FIG. 2 is a schematic sectional representation perpendicular to the abutment surface showing the valve according to the invention in a second embodiment;

FIG. 3 is a schematic sectional representation perpendicular to the abutment surface showing the valve according to the invention in a third embodiment;

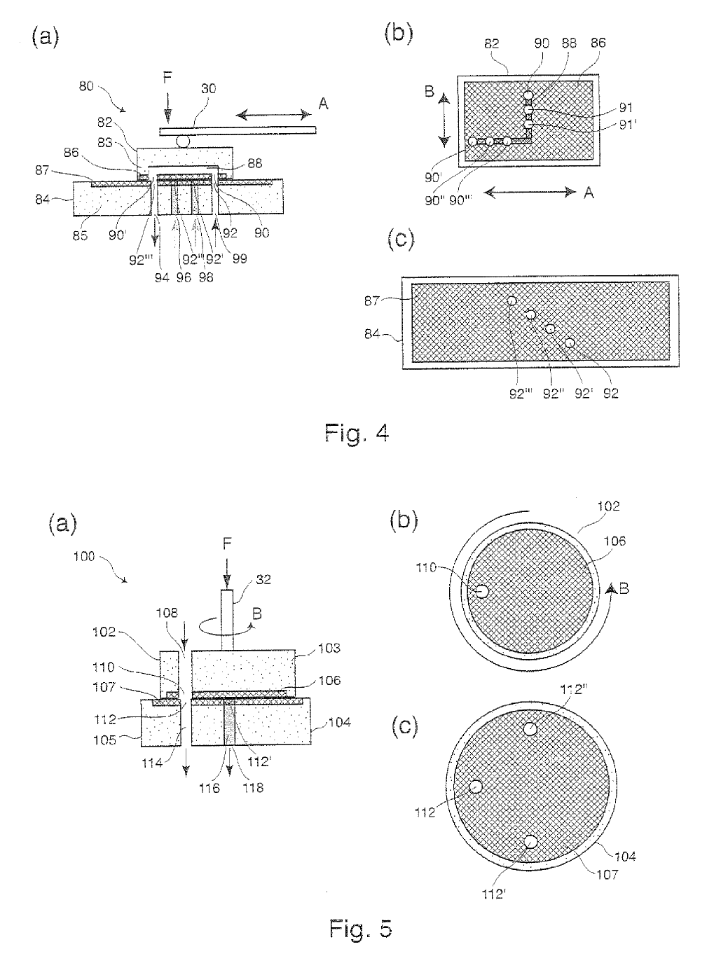

FIG. 4a is a schematic sectional representation perpendicular to the abutment surface showing the valve according to the invention in a fourth embodiment, FIG. 4b is a bottom view of the first valve element of the valve of the fourth embodiment, and FIG. 4c is a top view of the second valve element of the valve of the fourth embodiment;

FIG. 5a is a schematic sectional representation perpendicular to the abutment surface showing the valve according to the invention in a fifth embodiment, FIG. 5b is a bottom view of the first valve element of the valve of the fifth embodiment, and FIG. 5c is a top view of the second valve element of the valve of the fifth embodiment;

FIG. 6a is a schematic sectional representation perpendicular to the abutment surface showing the valve according to the invention in a sixth embodiment, FIG. 6b is a bottom view of the first valve element of the valve of the sixth embodiment, and FIG. 6c is a top view of the second valve element of the valve of the sixth embodiment;

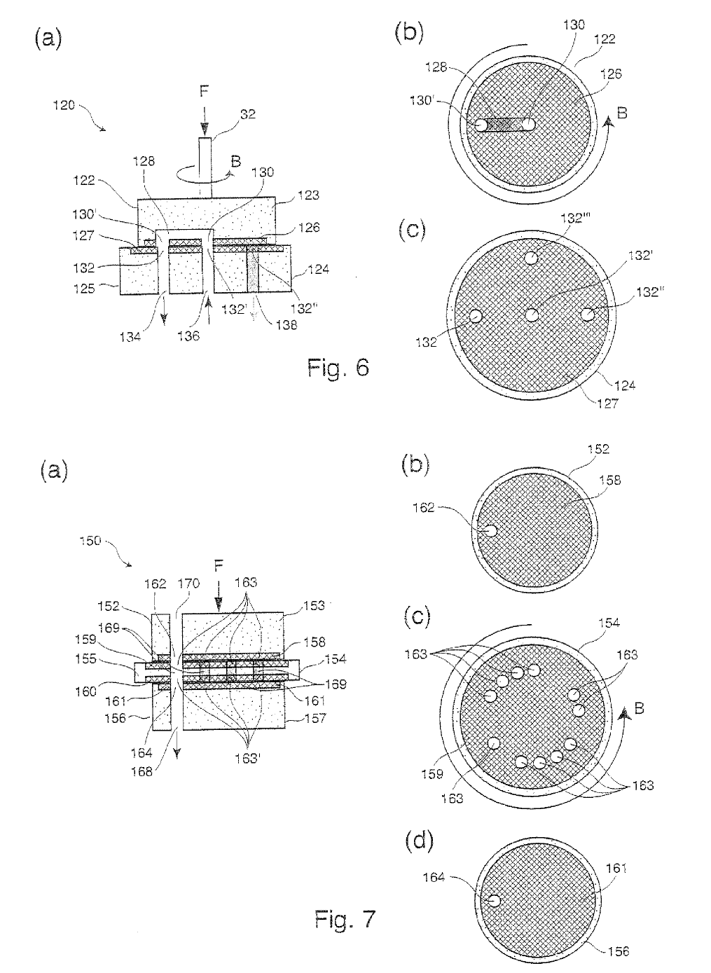

FIG. 7a is a schematic sectional representation perpendicular to the abutment surface showing the valve according to the invention in a seventh embodiment, FIG. 7b is a bottom view of the first valve element of the valve of the seventh embodiment, FIG. 7c is a top view of the second valve element of the valve of the seventh embodiment, and FIG. 7d is a top view of the third valve element of the valve of the seventh embodiment;

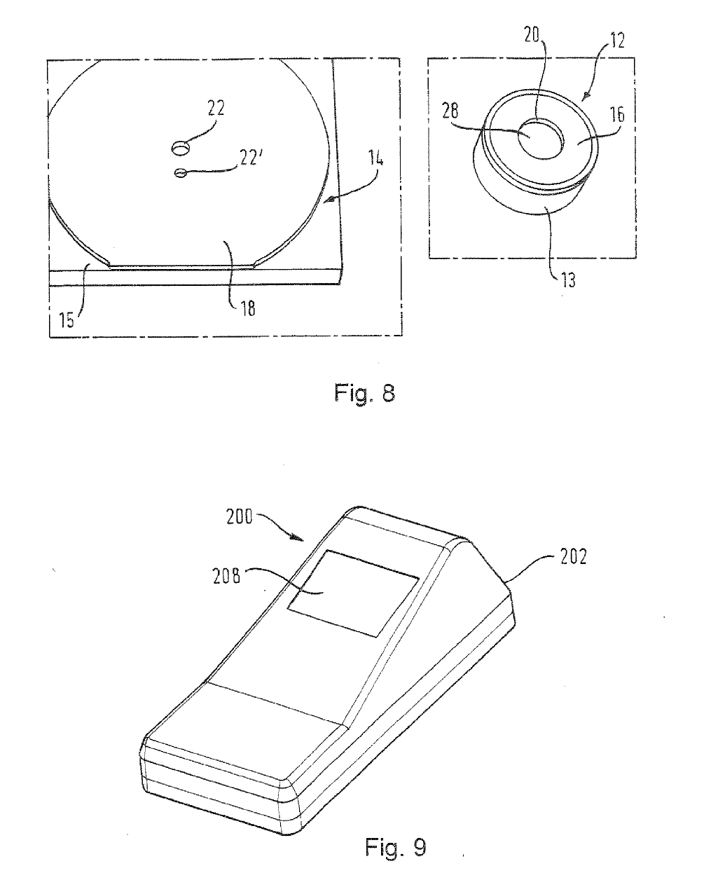

FIG. 8 is a perspective view of a first and a second valve element of the valve according to the invention;

FIG. 9 is a schematic perspective view of a measuring device according to the invention;

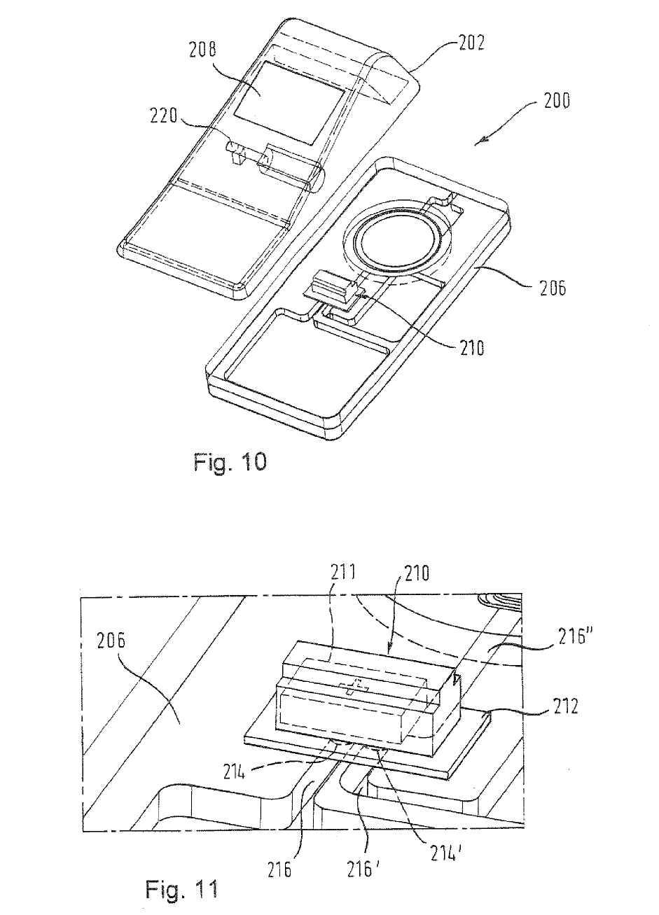

FIG. 10 is a schematic perspective view of the measuring device according to the invention with the cover removed;

FIG. 11 is an enlarged schematic perspective view of the valve of the measuring device shown in FIGS. 9 and 10;

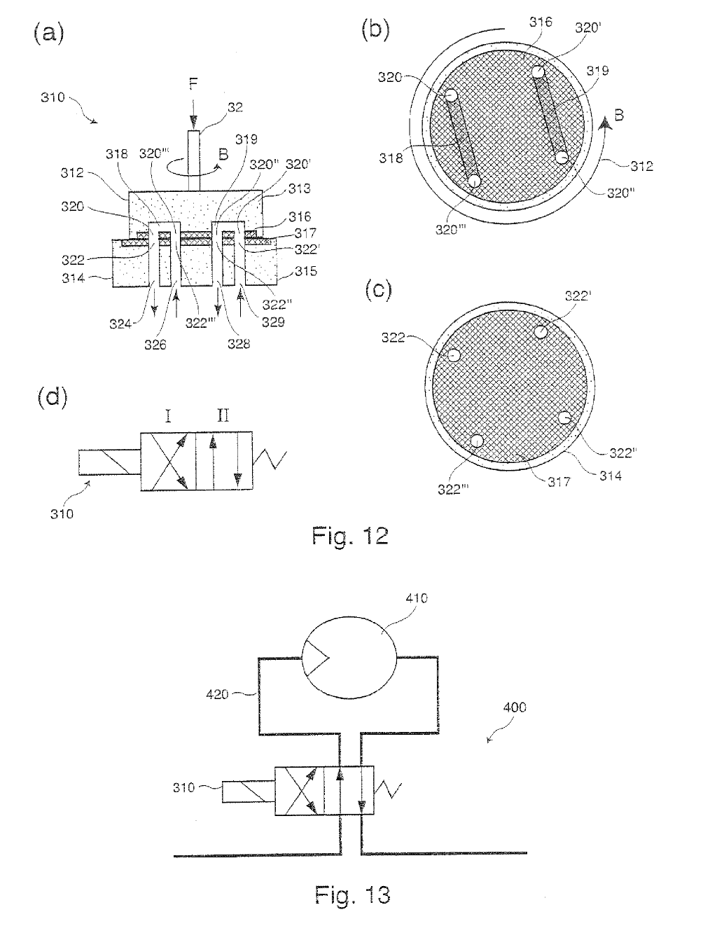

FIG. 12a is a schematic sectional representation perpendicular to the abutment surface showing the valve according to the invention in an eighth embodiment, FIG. 12b is a bottom view of the first valve element of the valve of the eighth embodiment, FIG. 12c is a top view of the second valve element of the valve of the eighth embodiment, and FIG. 12d is a possible diagram of the valve of the eighth embodiment (e.g. a 4/2-way valve);

FIG. 13 is a schematic diagram of the possible flow through the valve of the eighth embodiment, which shows the valve in use in a pump, wherein the valve (4/2-way valve) permits a change in the pumping direction;

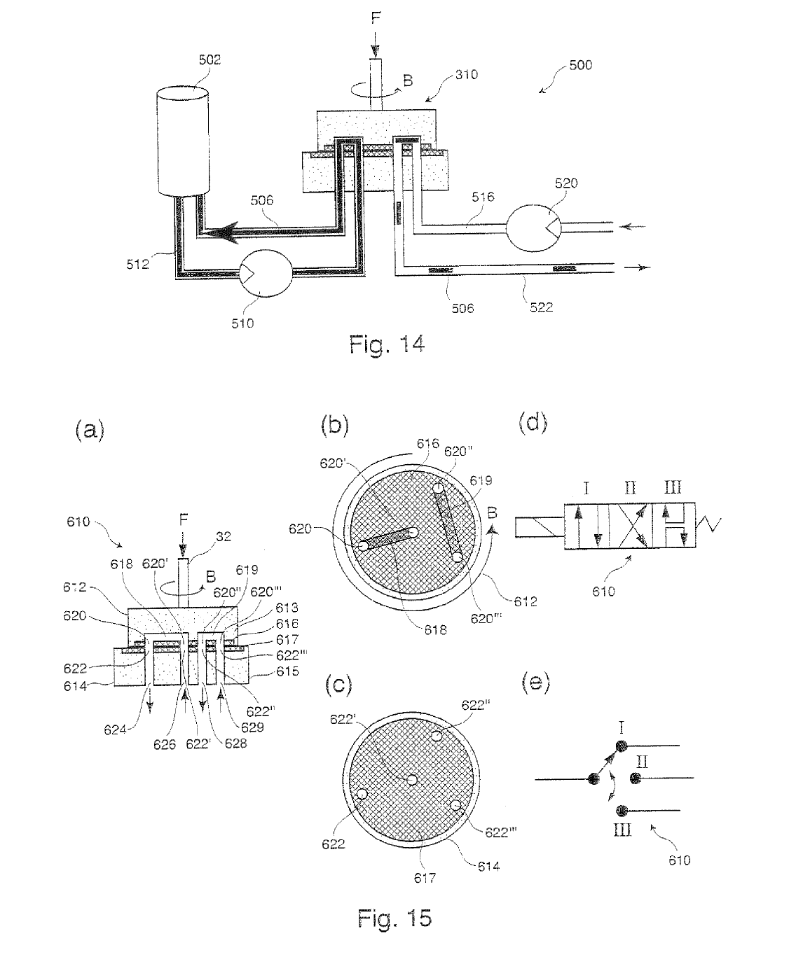

FIG. 14 is a further schematic diagram of the possible flow through the valve of the eighth embodiment, which shows the valve in use in a metering/mixing device, wherein the valve purposively supplies a precise small dose of a first fluid to a second stream of fluid;

FIG. 15a is a schematic sectional representation perpendicular to the abutment surface showing the valve according to the invention in a ninth embodiment, FIG. 15b is a bottom view of the first valve element of the valve of the ninth embodiment, FIG. 15c is a top view of the second valve element of the valve of the ninth embodiment, and FIGS. 15d and 15e are possible diagrams of the valve of the ninth embodiment (e.g. a 4/3-way valve);

FIG. 16 is a schematic diagram of the possible flow through the valve of the ninth embodiment, which shows the valve in use with a pump in an atomization system, wherein the valve (4/3-way valve) permits a change of the fluid to be atomized (such as, for example, medicament 1, medicament 2 or cleaning liquid);

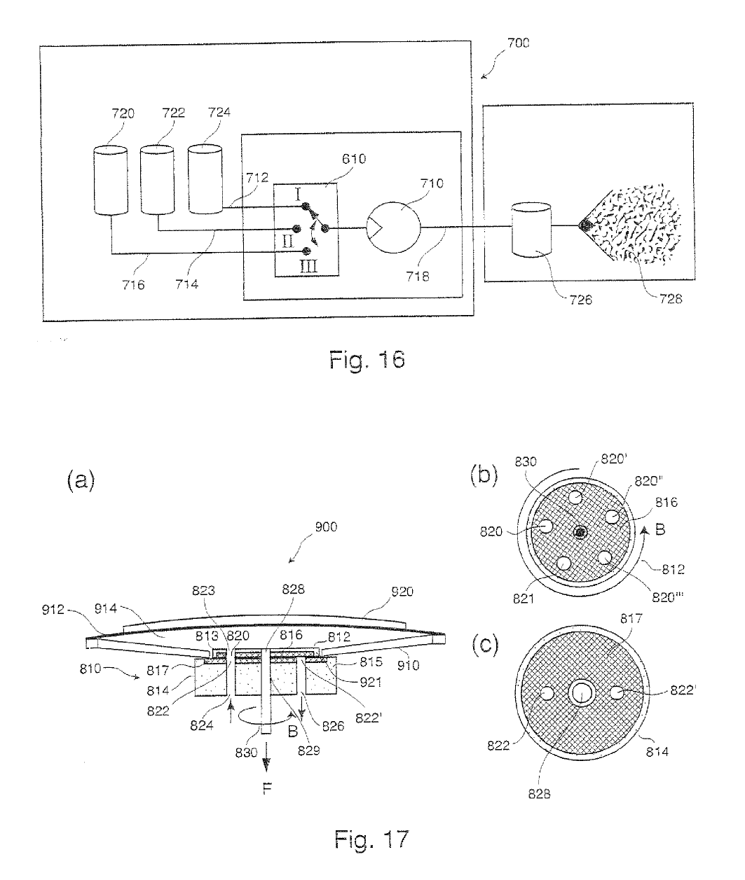

FIG. 17a is a schematic sectional representation perpendicular to the abutment surface showing the valve according to the invention in a tenth embodiment in use in a pump (e.g. a micropump), FIG. 17b is a bottom view of the first valve element of the valve of the tenth embodiment, and FIG. 17c is a top view of the second valve element of the valve of the tenth embodiment, wherein the valve is synchronized with the pump and permits a change in direction or mixing of the fluids;

FIG. 18a is a schematic sectional representation perpendicular to the abutment surface showing the valve according to the invention in an eleventh embodiment, FIG. 18b is a bottom view of the first valve element of the valve of the eleventh embodiment, and FIG. 18c is a top view of the second valve element of the valve of the eleventh embodiment (e.g. a regulating valve); and

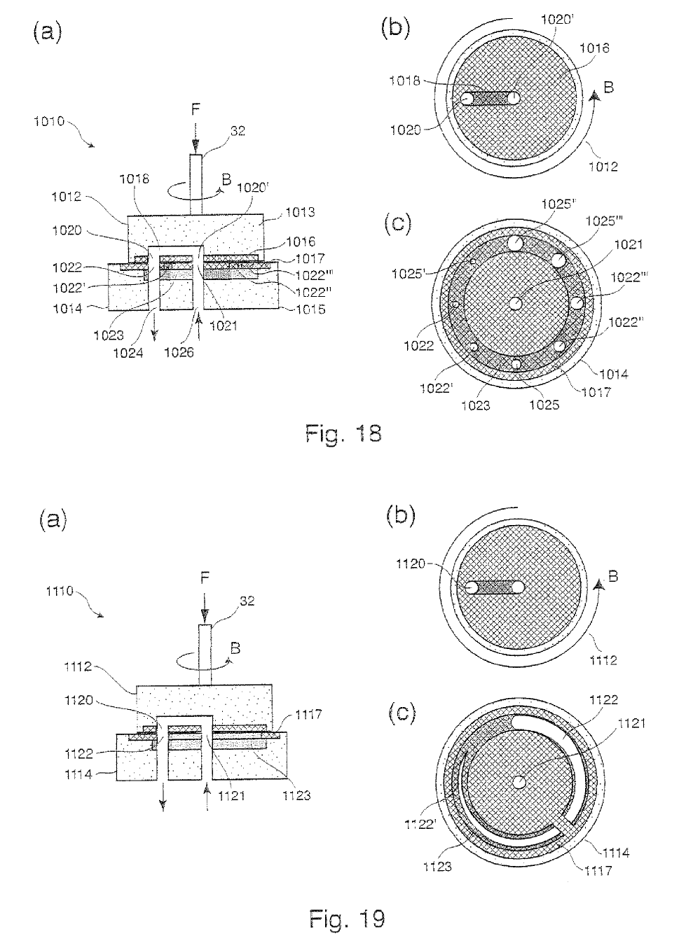

FIG. 19a is a schematic sectional representation perpendicular to the abutment surface showing the valve according to the invention in a twelfth embodiment, FIG. 19b is a bottom view of the first valve element of the valve of the twelfth embodiment, and FIG. 19c is a top view of the second valve element of the valve of the twelfth embodiment (e.g. a regulating valve).

FIGS. 1a and 1b show schematic sectional representations of the valve 10 in a first embodiment of the invention perpendicular to the abutment surface between the planar elements 16, 18. The valve 10 comprises a first valve element 12 having a first carrier part 13 and a first planar element 16, and a second valve element 14 having a second carrier part 15 and a second planar element 18. The first and the second planar element 16, 18 are formed of silicon, have two first openings 20, 20′ and two second openings 22, 22′, respectively, and abut one another at least partially in a planar manner along an abutment surface. The carrier parts 13, 15 consist of polycarbonate (PC) and are connected to the respective planar elements 16, 18 by hot stamping. The planar elements 16, 18 have a thickness of not more than 3 mm.

Fluid channels 24, 26, 28 are provided in the carrier parts 13, 15, the first fluid channel 24 of the second carrier part 15 being in the form of a fluid inlet, and the second fluid channel 26 of the second carrier part 15 being in the form of a fluid outlet. The two fluid channels 24, 26 each extend through the entire thickness of the carrier part 15. The first fluid channel 24 is in fluid connection with one second opening 22′ and the second fluid channel 26 is in fluid connection with the other second opening 22 of the second planar element 18. The fluid channel 28 of the first valve element 12 is in the form of a recess which is covered completely by the first planar element 16, the two first openings 20, 20′ of the first planar element 16 being in fluid connection with one another by way of the recess.

By means of an actuator 30, such as, for example, a piezoelectric element, which is connected at one end to the first carrier part 13 of the first valve element 12, the first valve element 12 can be moved to and fro relative to the fixed second valve element 14 in a direction A. In order to ensure a particularly tight fluidic connection between the valve elements 12, 14, an external force F, which preferably has values ≦15 N, is additionally applied to the first valve element 12 in a direction perpendicular to the abutment surface between the planar elements 16, 18, the abutment surface in the present case having a surface area of 3 mm×6 mm. The force per unit area is preferably ≦1 N/mm² and is particularly preferably in the range of from 0.01 N/mm² to 1 N/mm². This application of force can take place, for example, by way of the actuator 30. The above-mentioned dimensions, force ranges and materials also apply to the further embodiments of the invention described below.

The functioning of the valve 10 according to the first embodiment of the invention illustrated in FIGS. 1a and 1b will be described below. The valve 10 has a second position (valve position) shown in FIG. 1a and a first position shown in FIG. 1b. In the first position of the valve 10, the first fluid channel 24 of the second carrier part 15 is in fluid connection with the outside of the second valve element 14 by way of the corresponding second opening 22′ of the second planar element 18, so that there can be sucked into the valve 10 air from the outside or, when the valve 10 is used in a device for body fluids, a body fluid, such as, for example, blood, for example by way of an attached plastics capillary or directly. By operating the actuator 30, the first valve element 12 can be displaced in a linear manner in direction A into the first position shown in FIG. 1b (to the left in the sectional representations shown FIGS. 1a and 1b), in which one first opening 20 is in fluid connection with one second opening 22 and the other first opening 20′ is in fluid connection with the other second opening 22′. In that manner, the fluid channels 24, 26 of the second carrier part 15 are brought into fluid connection with one another by way of the fluid channel 28 of the first carrier part 13. The transport of a fluid from the second fluid channel 26 into the first fluid channel 24 (or vice versa) is accordingly made possible, in order, for example, to guide a calibration, carrier, marker or rinsing liquid through the fluid channel 24.

The valve 40 according to a second embodiment of the invention shown in FIG. 2 has, similarly to the above-described valve 10 of the first embodiment, first and second valve elements 42, 44 each having a plastics carrier part 43, 45 and a silicon planar element 46, 47 fastened thereto by hot stamping, as well as an actuator 30 for moving the first valve element 42 to and fro relative to the fixed second valve element 44 in direction A. In the first carrier part 43 there is provided a recess 48, which is in fluid connection with a first opening 50 in the first planar element 46. Furthermore, the second carrier part 45 is provided with three fluid channels 54, 56, 58, which are each in fluid connection with one of the second openings 52, 52′, 52″ in the second planar element 47. The first and the third fluid channel 54, 58 are in the form of fluid inlets, while the second fluid channel 56 is in the form of a fluid outlet, as is indicated by the arrows in FIG. 2. In FIGS. 3 to 7 too, the arrows provided on the fluid channels denote the direction of flow of a fluid through the valve, this representing an optional direction of flow in the respective figures for the purpose of description. The direction of flow can, of course, also be chosen the other way round for other applications.

By moving the first valve element 42 in direction A relative to the second valve element 44 by means of the actuator 30, the first fluid channel 54 and the second fluid channel 56 can be brought into fluid connection with one another by way of the recess 48, as is shown in FIG. 2, or the fluid channels 56, 58 can be brought into fluid connection with one another. Moreover, a closed position of the valve elements 42, 44 is also possible, in which none of the second openings 52, 52′, 52″ of the second planar element 47, and accordingly also none of the fluid channels 54, 56, 58, is in fluid connection with the recess 48 by way of the first opening 50. In that manner, two different fluid inlets 54, 58 of the second valve element 44, depending on the position of the valve elements 42, 44, can be brought into fluid connection with a fluid outlet 56 of the second valve element 44. Such a construction is advantageous, for example, when the valve 40 is used as a multiway valve in a measuring device for body fluids, in particular when a plurality of different liquids, such as, for example, the body fluid to be measured, a calibration liquid and/or a rinsing liquid, etc., must be transported through the valve 40.

FIG. 3 shows a valve 60 according to a third embodiment of the invention. The valve 60 comprises a first valve element 62 having a first plastics carrier part 63 and a first silicon planar element 66 fastened thereto by hot stamping, and a second valve element 64 having a plastics carrier part 65 and a second silicon planar element 67 fastened thereto by hot stamping. The second valve element 64 of the valve 60 according to the third embodiment is of similar construction to the second valve element 14, shown in FIG. 1, of the valve 10 according to the first embodiment. The second carrier part 65 has two fluid channels 74, 76, each of which is in fluid connection with an opening 72, 72′ of the second planar element 67. Moreover, the first carrier part 63, similarly to the embodiments shown above, has a recess 68 which is in fluid connection with a first opening 70 of the first planar element 66. In addition, there is formed in the first carrier part 63 a fluid channel 78 which is in fluid connection at one end with another first opening 70′ of the first planar element 66 and at its other end with the outside of the first valve element 62.

By operating the actuator 30, the first valve element 62 can be moved to and fro in direction A relative to the fixed second valve element 64 and thereby brought into different open and closed positions. In the valve position shown in FIG. 3, the fluid channel 78 is in fluid connection with the fluid channel 74 by way of the openings 70′, 72′, so that fluid communication with the outside of the first valve element 62 is made possible, for example for the supply or discharge of a body fluid. Furthermore, the first valve element 62 can be so displaced in direction A (to the left in the sectional representation shown in FIG. 3) that the fluid channels 74, 76 of the second carrier part 65 are brought into fluid connection with one another by way of the recess 68 in the first carrier part 63, similarly to the arrangement shown in FIG. 1b.

FIG. 4 shows a valve 80 according to a fourth embodiment of the invention, which valve 80 comprises a first valve element 82 having a first plastics carrier part 83 and a first silicon planar element 86 fastened thereto by hot stamping, and a second valve element 84 having a second plastics carrier part 85 and a second silicon planar element 87 fastened thereto by hot stamping. The first planar element 86 has six first openings 90, 90′, 90″, 90′″, 91, 91′ which are in fluid connection with one another by way of a fluid channel 88 formed in the first carrier part 83, as is shown in FIG. 4b. In the regions between the first openings 90, 90′, 90″, 90′″, 91, 91′, the fluid channel 88 is covered by the first planar element 86, as is shown schematically in FIG. 4b. The fluid channel 88 can accordingly be formed in a simple manner as a continuous depression or groove in the first carrier part 83, for example by using a suitable mold insert in an injection molding or compression molding process. Depending on the application, the fluid channel 88 may not be covered by the planar element 86 and be in the form of an open recess (such as, for example, a groove). As a result, the limiting cross-section of the fluid channel 88, for example, can be enlarged and the throughput can accordingly be increased.

Furthermore, there are formed in the second carrier part 85 four fluid channels 94, 96, 98, 99, which are in fluid connection with respective second openings 92, 92′, 92″, 92′″ in the second planar element 87. As is shown in FIGS. 4b and 4c, both the first openings 90, 90′, 90″, 90′″, 91, 91′ and the second openings 92, 92′, 92″, 92′″ are arranged offset in the horizontal and vertical direction (directions A and B in FIG. 4) when the valve elements 82, 84 are viewed from the top. In that manner, the positions of the openings can be adapted to the field of use of the valve 80, and the space requirement can be reduced, which allows the planar elements 86, 87 and accordingly the valve 80 to be reduced in size. Machining processes known from silicon technology allow the openings 90, 90′, 90″, 90′″, 91, 91′, 92, 92′, 92″, 92′″ in the planar elements 86, 87 to be arranged very close to one another. Openings as a complete matrix, which openings are offset relative to one another in directions A and B in FIG. 4, are also conceivable.

By operating the actuator 30, the first valve element 82 can be moved in direction A relative to the fixed second valve element 84 into different open or closed positions. In the position shown in FIG. 4a, the fluid channel 94 is in fluid connection with the fluid channel 99 by way of the openings 92′″, 90′, the fluid channel 88 and the openings 90, 92, while the openings 90″, 90′″, 91, 91′ of the first planar element 86 are covered by the second planar element 87 and the openings 92′, 92″ of the second planar element 87 are covered by the first planar element 86.

By displacing the first valve element 82 further relative to the second valve element 84 (to the left in the sectional representation shown in FIG. 4a), the fluid channel 98 can be brought into fluid connection with the fluid channel 24 by way of the openings 92′, 91, the fluid channel 88 and the openings 90″, 92′. In a further open position of the valve 80, the fluid channel 96 can be brought into fluid connection with the fluid channel 94 by way of the openings 92″, 91′, the fluid channel 88 and the openings 90′″, 92′. The valve 80 according to the fourth embodiment shown schematically in FIG. 4 is accordingly in the form of a four-way valve with three open valve positions. The valves 10, 40, 60, 80 according to the first to fourth embodiments shown in FIGS. 1 to 4 are in the form of sliding valves, in which switching of the valve 10, 40, 60, 80 takes place by a parallel displacement of the valve elements relative to one another in direction A. As has already been described above, the valve according to the invention can, however, also be in the form of a rotary valve. Various preferred embodiments of such a rotary valve according to the invention will be described in detail below with reference to FIGS. 5 to 7.

FIG. 5 shows a valve 100 according to a fifth embodiment of the invention, which valve 100 comprises a first valve element 102 having a first plastics carrier part 103 and a first silicon planar element 106 fastened thereto by hot stamping, and a second valve element 104 having a second plastics carrier part 105 and a second silicon planar element 107 fastened thereto by hot stamping.

The first carrier part 103 has a fluid channel 108 which is in fluid connection at one end with the outside of the first valve element 102 and at its other end with a first opening 110 provided in the planar element 106. In the second carrier part 105 there are formed three fluid channels 114, 116, 118, which are each in fluid connection at one end with the outside of the second valve element 112 and at their other end with respective second openings 112, 112′, 112″ of the second planar element 107. In the representation of FIG. 5a, the channels 116 and 118 are arranged offset behind one another in the direction perpendicular to the plane of projection. As is shown in FIGS. 5b and 5c, both the first valve element 102 and the second valve element 104 are circular, the first opening 110 being arranged close to the peripheral edge of the first valve element 102 and the openings 112, 112′, 112″ being arranged close to the peripheral edge of the second valve element 104 at arbitrary intervals (identical, as in FIG. 5, or different), as required by the application. Different fluid connections or fluid channel closures can thereby be achieved. The fluid transport can accordingly be adjusted depending on the switching speeds. It is also conceivable to configure the openings as rounded opening regions. Moreover, the second planar element 107 can be provided with any desired number of second openings, depending on the application of the valve. For example, a construction with four second openings is possible, in which a further second opening is added to the second openings 112, 112′, 112″ shown in FIG. 5c, for example in the portion of the peripheral edge of the second valve element 104 opposite the second opening 112.

By means of an actuator 32, such as, for example, an electric motor, which is connected at one end to the first valve element 102, the first valve element 102 can be rotated relative to the fixed second valve element 104 about an axis perpendicular to the abutment surface between the planar elements 106, 107, that is to say in direction B in FIG. 5. In that manner, the first opening 110 can be brought into fluid connection with each of the second openings 112, 112′, 112″ by rotation of the first valve element 102, and a flow of fluid through the valve 100 by way of three different flow paths can accordingly be made possible. When the valve 100 is used in a device, it is possible, for example, to transport a fluid fed into the fluid channel 108 from the outside into different regions of the device by way of one of the fluid channels 114, 116, 118.

FIG. 6 shows a valve 120 according to a sixth embodiment of the invention, which valve 120 comprises a first valve element 122 having a first plastics carrier part 123 and a first silicon planar element 126 fastened thereto by hot stamping, and a second valve element 124 having a second plastics carrier part 125 and a second silicon planar element 127 fastened thereto by hot stamping. The first planar element 126 has two first openings 130, 130′ which are in fluid connection with one another by way of a fluid channel 128 in the carrier part 123. In the region between the first openings 130, 130′, the fluid channel 128 is covered by the first planar element 126, as is shown schematically in FIG. 6b. The fluid channel 128 can accordingly be formed in a simple manner as a continuous depression or groove in the first carrier part 123, for example by using a suitable mold insert in an injection molding or compression molding process. Alternatively, the fluid channel 128 can be configured as a recess (e.g. groove) which is not covered by the planar element 126. As a further alternative, the fluid channel 128 can be formed only in the planar element 126 and be used, for example, as a limiting element of the fluid channel connection (restrictor).

Four fluid channels are additionally provided in the second carrier part 125, of which only three are shown in FIG. 6a, namely the channels 134, 136, 138. In the representation of FIG. 6a shown, the fourth fluid channel (not shown) is arranged behind the channel 136 offset in the direction perpendicular to the plane of projection. The fluid channels are in fluid connection at one end with the outside of the second valve element 124 and at the other end with respective second openings 132, 132′, 132″, 132′″ in the second planar element 127.

As is apparent from FIGS. 6b and 6c, the first openings 130, 130′ of the first planar element 126 and the second openings 132, 132′, 132″, 132′″ of the second planar element 127 are so arranged that the opening 130 is always in fluid connection with the opening 132′ of the second planar element 127 even when the first valve element 122 is rotated relative to the fixed second valve element 124 in direction B, because the axis of rotation about which the rotation takes place passes through the center of the first opening 130 and of the second opening 132′. The axis of rotation is accordingly congruent with the central axis in the longitudinal direction of the first opening 130 and of the second opening 132′. The first opening 130′ can be brought into fluid connection with each of the second openings 132, 132″, 132′″ by rotation of the valve elements 122, 124 relative to one another. In that manner, a fluid connection between the fluid channel 136 and each of the other fluid channels can be produced in a simple manner and with a short switching time. Furthermore, the second planar element 127 can be provided with any desired number of second openings, depending on the application of the valve. For example, a construction with five second openings is possible, in which a further second opening is added to the second openings 132, 132′, 132″, 132′″ shown in FIG. 6c, for example in the portion of the peripheral edge of the second valve element 124 opposite the second opening 132′″.

FIG. 7 shows a valve 150 according to a seventh embodiment of the invention, which valve 150 comprises a first valve element 152 having a first plastics carrier part 153 and a first silicon planar element 158 fastened thereto by hot stamping, a second valve element 154 having a second plastics carrier part 155 and two second silicon planar elements 159, 160 fastened thereto by hot stamping, and a third valve element 156 having a third plastics carrier part 157 and a third silicon planar element 161 fastened thereto by hot stamping. The valve elements 152, 154, 156 are so arranged that the first planar element 158 abuts one second planar element 159 of the second valve element 154 at a first abutment surface at least partially in a planar manner, and the third planar element 161 of the third valve element 156 abuts the other second planar element 160 of the second valve element at a second abutment surface, which is parallel to the first abutment surface, at least partially in a planar manner.

The first carrier part 153 has a fluid channel 170 which is in fluid connection at one end with the outside of the first valve element 153 and at its other end with a first opening 162 in the first planar element 158, and the third carrier part 157 has a fluid channel 168 which is in fluid connection at one end with the outside of the third valve element 156 and at its other end with a third opening 164 in the third planar element 161. One second planar element 159 of the second valve element 154 has eleven second openings 163, which are arranged close to the periphery of the circular planar element 159 and are each in fluid connection with corresponding second openings 163′ in the other second planar element 160 of the second valve element 154 by way of fluid channels 169 in the second carrier part 155. Alternatively, the second openings 163, which are arranged close to the periphery of the circular planar element 159, can be arranged at equal or different intervals, depending on the desired application, use or switching of the valve according to the invention. In addition, one second planar element 159 can be provided with any desired number of second openings, depending on the application of the valve, the intervals between which can each be chosen suitably.

The first valve element 152 and the third valve element 156 are arranged fixedly, while the second valve element 154 can be rotated relative to the other two valve elements 152, 156 about an axis perpendicular to the abutment surfaces. As is apparent from FIG. 7, the flow path of a fluid through the valve 150 is not changed by a rotation of the second valve element 154 relative to the other two valve elements 152, 156, even when different fluid channels 169 are brought into fluid connection with the fluid channels 170, 168. However, owing to the circular arrangement of the plurality of openings 163, 163′ and corresponding fluid channels 169 at small intervals in the peripheral direction of the second valve element 154, rapid opening and closing of the valve 150 is made possible, depending on whether the openings 163, 163′ or the regions of the planar elements 159, 160 arranged between those openings are located opposite the openings 162, 164, without the direction of rotation B of the valve having to be reversed. In that manner, particularly simple operation of the valve 150 with very short switching times is achieved.

FIG. 8 shows a perspective view of a first valve element 12 and a second valve element 14 according to the above-described first embodiment of the invention, wherein the first valve element 12 has a first planar element 16 having only one first opening 20. The planar elements 16, 18 are made of silicon and are each adhesively bonded into the plastics carrier parts 13, 15. For the second planar element 18, a silicon or silicon oxide wafer in the unprocessed state can be used, so that, apart from the provision of the openings 22, 22′, no further machining steps are necessary. The surfaces of the planar elements 16, 18 can, however, be polished in order thus to achieve a particularly high degree of surface evenness and accordingly an even tighter fluidic connection between the two valve elements 12, 14.

In order to determine the tightness of a valve according to the invention, tests were carried out in which a valve element consisting of a plastics carrier part and a silicon planar element fastened thereto was pressed with a defined force F₄ onto the surface of a silicon wafer. Compressed air at a pressure p₁ was then supplied to the element at a fluid port of the valve element. The leakage rate of this valve connection was determined by means of an air flow meter. The measurement results of these tests are shown in Table 1.

TABLE 1
Air leakage rate in dependence on pressure and force at the
valve connection with a silicon surface area of 3 mm × 6 mm.

| Force F₁ [N] | Pressure p₁ [mbar] | Air Leakage rate [ml/min] |
|---|---|---|
| 10 | 300 | 0.027 |
| 10 | 350 | 0.054 |
| 10 | 400 | 0.0444 |
| 10 | 450 | 0.045 |
| 10 | 500 | 0.0546 |
| 5 | 500 | 0.2058 |
| 3 | 500 | 0.5268 |
| 2 | 500 | 0.7908 |
| 1 | 500 | 1.9206 |

These measurement data show that, even with low external forces F₁, very high tightness of the valve connection can be achieved (leakage rates of less than 0.3 ml/min at a force F₁ of 5 N and a pressure p₁ of 500 mbar).

FIGS. 9 and 10 show schematic representations of a measuring device 200 for measuring the blood glucose level, wherein a cover 202 of the device 200 has been removed in FIG. 10. The measuring device 200 has a display 208 for displaying measurement results, and a valve 210 according to the invention. In principle, any of the valves disclosed herein can be used as a valve 210 for the measuring device 200. An enlarged representation of the valve 210 of the measuring device 200 is shown in FIG. 11. The valve 210 has a first valve element 211, the bottom part 206 of the measuring device 200 acting as the second valve element. The bottom part 206 of the measuring device 200 has a silicon planar element 212 having two openings 214, 214′, as well as fluid channels 216, 216′ arranged beneath the openings 214, 214′ and connected thereto. Moreover, the silicon planar element 212 has a further second opening (not shown in FIG. 11), which is connected to a further fluid channel 216″ in the bottom part 206 of the measuring device 200. The fluid channels 216, 216′, 216″ can suitably be brought into fluid connection with one another by way of one or more fluid channels (not shown in FIGS. 10 and 11) formed in the first valve element 211, by appropriate switching of the valve 210. In that manner, the blood to be measured can be transported through the measuring device 200. Moreover, the presence of three fluid channels 216, 216′, 216″ enables further liquids, such as, for example, calibration and rinsing liquids, to be transported through the device 200. Accordingly, an automatic calibration operation of the measuring device 200 is possible before the body fluid is measured, and an automatic rinsing operation is possible when the measurement has taken place.

FIGS. 10 and 11 show a particularly advantageous construction of the valve 210, in which the valve 210 has an actuator 220, such as, for example, a piezoelectric element, which is uncoupled or can be uncoupled. The actuator 220 is arranged in the cover 202 of the measuring device 200 and, when the cover 202 is fitted onto the bottom part 206 of the measuring device 200, engages into the valve 210 so that the valve 210 can be operated by the actuator 220. Even if the bottom part 206 of the device is disposed of, the cover 202 with the actuator 220 can accordingly be re-used.

FIG. 12 shows a valve 310 according to an eighth embodiment of the invention, which valve 310 is similar in its fundamental construction to the valve 120 shown in FIG. 6 but is in the form of a 4/2-way valve. The valve 310 comprises a first valve element 312 having a first plastics carrier part 313 and a first silicon planar element 316 fastened thereto by hot stamping, and a second valve element 314 having a second plastics carrier part 315 and a second silicon planar element 317 fastened thereto by hot stamping. The first planar element 316 has four first openings 320, 320′, 320″, 320′″, two of the openings 320, 320′″ being in fluid connection with one another by way of a first fluid channel 318 and the other two openings 320′, 320″ being in fluid connection with one another by way of a second fluid channel 319 in the carrier part 313. In the regions between the first openings 320, 320′″ and the first openings 320′, 320″, the fluid channels 318, 319 are each covered by the first planar element 316, as is shown schematically in FIG. 12b. The fluid channels 318, 319 can accordingly be formed in a simple manner as continuous depressions or grooves in the first carrier part 313, for example by using a suitable mold insert in an injection molding or compression molding process. Alternatively, the fluid channels 318, 319 can be in the form of recesses (e.g. grooves) which are not covered by the planar element 316. As a further alternative, the fluid channels 318, 319 can be formed only in the planar element 316 and can be used, for example, as limiting elements of the fluid channel connection (restrictors).

In addition, there are provided in the second carrier part 315 fluid channels 324, 326, 328, 329 which are in fluid connection at one end with the outside of the second valve element 314 and at their other end with respective second openings 322, 322′, 322″, 322′″ in the second planar element 317.

As is apparent from FIGS. 12b and 12c, the first openings 320, 320′, 320″, 320′″ of the first planar element 316 and the second openings 322, 322′, 322″, 322′″ of the second planar element 317 are so arranged that, when the first valve element 312 is suitably rotated relative to the fixed second valve element 314 in direction B, they can be brought into fluid connection with one another in pairs. In that manner, the valve 310 can be so positioned that either the fluid channel 324 is in fluid connection with the fluid channel 326 and the fluid channel 328 is in fluid connection with the fluid channel 329 (valve position I) or the fluid channel 324 is in fluid connection with the fluid channel 329 and the fluid channel 326 is in fluid connection with the fluid channel 328 (valve position II) by way of the fluid channel 318 or the fluid channel 319 in the first carrier part 313. FIG. 12d is a possible diagram of the valve 310, which shows these two valve positions schematically.

The valve 310 according to the eighth embodiment can accordingly be used, for example, in a pump or micropump for permitting a change in the pumping direction. FIG. 13 shows a schematic construction of such a pump or micropump 400. As is apparent from the figure, the pump 400 has a pump element 410 for generating a pumping pressure, the valve 310, and a fluid line 420 which is in fluid communication with the pump element 410 and the valve 310. By bringing the valve from valve position I into valve position II (or vice versa), the direction of the flow of fluid in the part of the fluid line 420 on the side of the valve 310 remote from the pump element 410 is reversed, and the pumping direction (conveying direction) of the pump (micropump) 400 can accordingly be changed in a simple manner merely by operating the valve 310.

Moreover, the valve 310 according to the eighth embodiment can also be used in a metering/mixing device, as is shown schematically in FIG. 14. The metering/mixing device 500 has a medicament reservoir 502 for receiving and delivering a medicament 506 in fluid form, a first pump element 510, a first fluid line 512 for transporting the medicament 506, a second pump element 520, a second fluid line 522 for transporting a buffer solution 516, and the valve 310. In the first position of the valve 310 (valve position I), the medicament reservoir 502, the first pump element 510, the first fluid line 512 and the valve 310 form a closed medicament circuit, while the second pump element 520, the second fluid line 522 and the valve 310 form a buffer solution circuit. If the valve 310 is brought into the second valve position (II) for a short time, a precisely metered amount of the medicament 506 is transported by way of the valve 310 into the second fluid line 522 and there mixed with the buffer solution 516. With a constant pumping pressure of the pump elements 510, 520, it is possible to control the amount of medicament 506 delivered into the buffer solution 516 precisely for the period of time for which the valve 310 remains in the second valve position, and the valve channel volume (e.g. length and cross-section of the groove). Because the rotary valve according to the present invention has particularly short switching times, as has already been described above, high metering accuracy can accordingly be achieved. The field of use of the metering/mixing device 500 is not limited to medical applications, however. In fact, the metering/mixing device 500 can be used for metering and/or mixing any desired fluids.

FIG. 15 shows a valve 610 according to a ninth embodiment of the invention, which valve 610 is similar in its fundamental construction to the valve 310 shown in FIG. 12 but is in the form of a 4/3-way valve. The valve 610 comprises a first valve element 612 having a first plastics carrier part 613 and a first silicon planar element 616 fastened thereto by hot stamping, and a second valve element 614 having a second plastics carrier part 615 and a second silicon planar element 617 fastened thereto by hot stamping. The first planar element 616 has four first openings 620, 620′, 620″, 620′″, two of the openings 620, 620′ being in fluid connection with one another by way of a first fluid channel 618 and the other two openings 620″, 620′″ being in fluid connection with one another by way of a second fluid channel 619 in the carrier part 613. In contrast to the two fluid channels 318, 319 of the valve 310, the fluid channels 618, 619 of the valve 610 are arranged not parallel but perpendicular to one another.

In the regions between the first openings 620, 620′ and the first openings 620″, 620′″, the fluid channels 618, 619 are each covered by the first planar element 616, as is shown schematically in FIG. 15b. The fluid channels 618, 619 can accordingly be formed in a simple manner as continuous depressions or grooves in the first carrier part 613, for example by using a suitable mold insert in an injection molding or compression molding process. Alternatively, the fluid channels 618, 619 can be in the form of recesses (e.g. grooves) which are not covered by the planar element 616. As a further alternative, the fluid channels 618, 619 can be formed only in the planar element 616 and can be used, for example, as limiting elements of the fluid channel connection (restrictors).

In addition, there are provided in the second carrier part 615 fluid channels 624, 626, 628, 629 which are in fluid connection at one end with the outside of the second valve element 614 and at their other end with respective second openings 622, 622′, 622″, 622′″ in the second planar element 617.

As is apparent from FIGS. 15b and 15c, the first opening 620′ of the first planar element 616 and the second opening 622′ of the second planar element 617 are so arranged that they are always in fluid connection with one another even when the first valve element 612 is rotated relative to the fixed second valve element 614 in direction B, because the axis of rotation about which the rotation takes place passes through the center of the first opening 620′ and of the second opening 622′. The axis of rotation is accordingly congruent with the central axis in the longitudinal direction of the first opening 620′ and of the second opening 622′. In addition, the further first openings 620, 620″, 620′″ of the first planar element 616 and the further second openings 622, 622″, 622′″ of the second planar element 617 are so arranged that, when the first valve element 612 is suitably rotated relative to the second valve element 614 in direction B, they can be brought into fluid connection with one another so that either the fluid channel 624 is in fluid connection with the fluid channel 626 and the fluid channel 628 is in fluid connection with the fluid channel 629 (valve position I) or the fluid channel 626 is in fluid connection with the fluid channel 628 and the fluid channel 624 is in fluid connection with the fluid channel 629 (valve position II) or the fluid channel 626 is in fluid connection with the fluid channel 629 and the fluid channel 624 is in fluid connection with the fluid channel 628 (valve position III) by way of the fluid channel 618 or the fluid channel 619 in the first carrier part 613. FIGS. 15d and 15e are possible diagrams of the valve 610, which show these three valve positions schematically.

The valve 610 according to the ninth embodiment can accordingly be used, for example, in an atomization system. FIG. 16 shows the schematic construction of such an atomization system 600. As is apparent from the figure, the atomization system 700 has a pump element 710 for generating a pumping pressure, the valve 610, fluid lines 712, 714, 716, 718, a first medicament reservoir 720 for receiving and delivering a first medicament in fluid form, a second medicament reservoir 722 for receiving and delivering a second medicament in fluid form, a solution reservoir 724 for receiving and delivering a rinsing solution or a buffer solution, a mixture reservoir 726, and an atomization unit 728.

In the first position of the valve 610 (position I), a rinsing solution or a buffer solution is conveyed through the pump element 710 from the solution reservoir 724 by way of the fluid lines 712, 718 to the mixture reservoir 726. By switching the valve 610 into positions II and III, transport of the first medicament and/or of the second medicament to the mixture reservoir 726 can be effected in an analogous manner. The short switching times of the valve 610 permit particularly accurate metering. In the mixture reservoir 726, the supplied fluids are mixed and then conveyed to the atomization unit 728, which atomizes the fluid mixture, that is to say produces an aerosol from the mixture. The atomization unit 728 can be a membrane atomizer or a nozzle atomizer, for example. Alternatively, the atomization system 700 can also be configured without the mixture reservoir 726, so that the fluids are conveyed directly to the atomization unit 728. The field of use of the atomization system 700 is not limited to medical applications, however. In fact, the atomization system 700 can be used for mixing and/or atomizing any desired fluids. Moreover, the valve can also be configured with more than three possible valve positions, as a result of which the use of further fluid reservoirs is made possible.

FIG. 17 shows a valve 810 according to a tenth embodiment of the invention, which valve 810 is integrated into a micropump (membrane pump) 900. The valve 810 comprises a first valve element 812 having a first plastics carrier part 813 and a first silicon planar element 816 fastened thereto by hot stamping, and a second valve element 814 having a second plastics carrier part 815 and a second silicon planar element 817 fastened thereto by hot stamping. The first planar element 816 has five first openings 820, 820′, 820″, 820′″, 821, each of which is in fluid connection with the outside of the first valve element 814 by way of corresponding fluid channels in the first carrier part 813. In FIG. 20a, only one of these fluid channels 823 is shown. Moreover, the first valve element 812 has a rotary shaft 830 which is fastened centrally to the valve element 812 and the longitudinal axis of which extends perpendicularly to the abutment surface between the first 816 and the second 817 planar element.

In addition, there are provided in the second carrier part 815 two fluid channels 824, 826 which are in fluid connection at one end with the outside of the second valve element 814 and at their other end with respective second openings 822, 822′ in the second planar element 817. Furthermore, the second valve element 814 has a central opening 828, which communicates by way of a central channel 829 in the second carrier part 815 with the outside of the second valve element 814. The central opening 828 and the central channel 829 serve for the reception and passage of the rotary shaft 830.

In addition to the above-described valve 810, the micropump 900 has a first 910 and a second 912 substantially disk-shaped membrane (preferably made of metal, e.g. stainless steel), which are connected together at their peripheral edges in such a manner that, with corresponding deflection of the membranes 910, 912, they form a fluidically tight pump chamber 914 between them and the valve 810, and a vibration element 920 for the periodic deflection of the membranes 910, 912. The volume of the pump chamber 914 is controlled by the deflection of the membranes 910, 912 relative to one another. The valve 810 is fitted in a fluidically tight manner, for example by adhesive bonding, into an opening 921 of the second membrane 910, so that the fluid channels 823 of the first carrier part 813 are in fluid connection with the pump chamber 914. There can be used as the vibration element 920, for example, a piezoelectric element (piezo actuator), which can be suitably controlled from outside. As is indicated in FIG. 17a, in contrast to the valves described above, in the case of the valve 810 a tensile force instead of a compressive force is exerted by way of the rotary shaft 830 on the first valve element 812, in order to achieve a particularly tight fluidic connection between the valve elements 812 814.

As is apparent from FIGS. 17b and 17c, the first openings 820, 820′, 820″, 820′″, 821 of the first planar element 816 and the second openings 822, 822′ of the second planar element 817 are so arranged that, on rotation of the first valve element 812 relative to the fixed second valve element 814 in direction B, the fluid channel 824 and the fluid channel 826 of the second carrier part 815 are alternately brought into fluid connection with the pump chamber 914. By suitably synchronizing or timing the rotation of the first valve element 812 with the deflection of the membranes 910, 912 by the vibration element 920, for example by means of an external control device (not shown), a fluid can accordingly be conveyed by way of the fluid channel 824 into the pump chamber 914 and by way of the fluid channel 826 out of the pump chamber 914 (or vice versa, depending on the synchronization). In that case, the valve 810 is so switched that, in the case of an enlargement of the volume of the pump chamber 914 (suction), the fluid channel 824 is in fluid connection with the pump chamber 914, so that a fluid is sucked into the chamber 914, and in the case of a reduction in the volume of the pump chamber 914 (pumping), the fluid channel 826 is in fluid communication with the pump chamber 914, so that a fluid is conveyed out of the chamber 914.

Owing to the short switching times of the valve 810, a high fluid throughput can accordingly be achieved even with a small pump size. Moreover, the pumping direction can be reversed in a simple manner by suitably changing the synchronization. In addition, the pump construction shown schematically in FIG. 17 also permits combined mixing and pumping of fluids. For example, the pump 900 could be so synchronized that first a first fluid is sucked into the pump chamber 914 by way of the fluid channel 824 and then a second fluid is sucked into the pump chamber 914 by way of the fluid channel 826. These fluids are then mixed in the pump chamber 914 and can subsequently be delivered to the outside by way of one of the two pump channels 824, 826. Alternatively, further second openings could also be provided in the second planar element 817, which second openings, by way of additional fluid channels in the second carrier part 815, enable different fluids to be supplied from outside into the pump chamber 914. For example, two fluid channels in the second carrier part 815 could serve to supply two different fluids, which are mixed in the pump chamber 914 and then delivered to outside by way of a third fluid channel in the second carrier part 815.

FIG. 18 shows a valve 1010 according to an eleventh embodiment of the invention, which valve 1010 comprises a first valve element 1012 having a first plastics carrier part 1013 and a first silicon planar element 1016 fastened thereto by hot stamping, and a second valve element 1014 having a second plastics carrier part 1015 and a second silicon planar element 1017 fastened thereto by hot stamping. The first planar element 1016 has two first openings 1020, 1020′, which are in fluid connection with one another by way of a fluid channel 1018 in the carrier part 1013. In the region between the first openings 1020, 1020′, the fluid channel 1018 is covered by the first planar element 1016, as is shown schematically in FIG. 18b. The fluid channel 1018 can accordingly be formed in a simple manner as a continuous depression or groove in the first carrier part 1013, for example by using a suitable mold insert in an injection molding or compression molding process. Alternatively, the fluid channel 1018 can be in the form of a recess (e.g. groove) which is not covered by the planar element 1016. As a further alternative, the fluid channel 1018 can be formed only in the planar element 1016 and can be used, for example, as a limiting element of the fluid channel connection (restrictor). The second planar element 1017 has nine second openings 1021, 1022, 1022′, 1022″, 1022′″, 1025, 1025′, 1025″, 1025′″, the second openings 1022, 1022′, 1022″, 1022′″, 1025, 1025′, 1025″, 1025′″ being in fluid connection with one another by way of an annular fluid channel 1023 in the second carrier part 1015. In the region between the second openings 1022, 1022′, 1022″, 1022′″, 1025, 1025′, 1025″, 1025′″, the fluid channel 1023 is covered by the second planar element 1017, as is shown schematically in FIG. 18c. The fluid channel 1023 can accordingly be formed in a simple manner as a continuous depression or groove in the second carrier part 1015, for example by using a suitable mold insert in an injection molding or compression molding process.

In addition, two further fluid channels 1024, 1026 are provided in the second carrier part 1015. One of those channels 1026 is in fluid connection at one end with the outside of the second valve element 1014 and at its other end with the second opening 1021 in the second planar element 1017. The other of those channels 1024 is in fluid connection at one end with the outside of the second valve element 1014 and at its other end with the annular fluid channel 1023 of the second carrier part 1015.

As is apparent from FIGS. 18b and 18c, the first openings 1020, 1020′ of the first planar element 1016 and the second openings 1021, 1022, 1022′, 1022″, 1022′″, 1025, 1025′, 1025″, 1025′″ of the second planar element 1017 are so arranged that the opening 1021 is always in fluid connection with the opening 1021′ of the second planar element 1017 even when the first valve element 1012 is rotated relative to the fixed second valve element 1014 in direction B, because the axis of rotation about which the rotation takes place passes through the center of the first opening 1020′ and of the second opening 1021. The axis of rotation is accordingly congruent with the central axis in the longitudinal direction of the first opening 1020′ and of the second opening 1021. The first opening 1020 can be brought into fluid connection with each of the second openings 1022, 1022′, 1022″, 1022′″, 1025, 1025′, 1025″, 1025′″ by rotation of the valve elements 1012, 1014 relative to one another. In that manner, a fluid connection between the fluid channel 1026 and the fluid channel 1024 can be produced in a simple manner and with a short switching time by way of the fluid channel 1023. The second openings 1022, 1022′, 1022″, 1022′″, 1025, 1025′, 1025″, 1025′″ have opening cross-sections (passage cross-sections) of different sizes, as is apparent from FIG. 18c. Accordingly, the conveyed amount of a fluid to be transported can be controlled or regulated in a simple manner by suitably bringing the first opening 1020 into fluid connection with different second openings 1022, 1022′, 1022″, 1022′″, 1025, 1025′, 1025″, 1025′″ by rotation of the first valve element 1012 relative to the second valve element 1014 in direction B. The flow of fluid is metered by the different opening cross-sections. Consequently, the valve 1010 according to the eleventh embodiment of the invention is configured in a simple manner as a regulating valve which can be used particularly advantageously for a metering/mixing device, such as, for example, the device 500 shown in FIG. 14.

Furthermore, the second planar element 1017 can be provided with an arbitrary number of second openings, depending on the use of the valve 1010. As an alternative to the above-described valve construction, a construction is also possible in which the annular fluid channel 1023 is omitted and the second openings 1022, 1022′, 1022″, 1022′″, 1025, 1025′, 1025″, 1025′″ are directly in fluid connection with the outside of the second valve element 1014 by way of respective fluid channels formed in the second carrier part 1015.

FIG. 19 shows a valve 1110 according to a twelfth embodiment of the invention, which valve 1110 comprises a first valve element 1112 and a second valve element 1114. The construction of the first valve element 1112 is identical with that of the first valve element 1012 of the valve 1010 of the eleventh embodiment shown in FIG. 18 and is therefore not described in detail here in order to avoid repetition. The construction of the second valve element 1114 is similar to that of the second valve element 1014 of the above-described valve 1010, the fluid channel 1123 of the valve 1110 having not a continuous but an interrupted annular form and the second planar element 1117 having three second openings 1121, 1122, 1122′. The second openings 1122, 1122′ are in fluid connection with one another by way of the fluid channel 1123 and are configured as a gap with a gap width that changes continuously in the peripheral direction of the second valve element 1114, as is shown schematically in FIG. 19c.

In the valve 1110, the conveyed amount of a fluid to be transported can be controlled or regulated in a simple manner by suitably bringing the first opening 1120 into fluid connection with different sections of the second openings 1122, 1122′ by rotation of the first valve element 1112 relative to the second valve element 1114 in direction B. Because the change in the opening cross-section of the second openings 1122, 1122′ takes place continuously in the peripheral direction of the second valve element 1114, as has been discussed above, the conveyed amount of fluid or the flow of fluid can also be regulated continuously. Accordingly, the valve 1110 according to the twelfth embodiment of the invention is configured in a simple manner as a continuously regulating valve. The valve 1110 can accordingly also be used particularly advantageously for a metering/mixing device, such as, for example, the device 500 shown in FIG. 14.

The invention is not limited to the embodiments described but can be modified within the scope of the following patent claims.

1. Valve having a first valve element and a second valve element, wherein
the first valve element comprises a first carrier part of plastics material and a first planar element of silicon or silicon oxide which is fastened to the first carrier part,
the second valve element comprises a second carrier part of plastics material and a second planar element of silicon or silicon oxide which is fastened to the second carrier part,
the valve elements are so arranged that the first and the second planar element abut one another at least partially in a planar manner along an abutment surface,
the valve elements are movable relative to one another in at least one direction parallel to the abutment surface of the planar elements,
the first planar element has at least one first opening and the second planar element has at least one second opening,
the valve elements are movable relative to one another in the at least one direction parallel to the abutment surface into at least one first position, in which the at least one first opening and the at least one second opening are in fluid connection with one another, and at least one second position, in which the at least one first opening and the at least one second opening are not in fluid connection with one another.

2. Valve according to claim 1 which is a multiway valve, in which the first planar element has a plurality of first openings and/or the second planar element has a plurality of second openings, wherein the valve elements are movable relative to one another in the at least one direction parallel to the abutment surface into a plurality of different first positions, in each of which at least one of the first openings is in fluid connection with at least one of the second openings.

3. Valve according to claim 1, in which the first carrier part has at least one fluid channel which is in fluid connection with one or more of the first openings, and/or the second carrier part has at least one fluid channel which is in fluid connection with one or more of the second openings.

4. Valve according to claim 3, in which the first planar element has two first openings which are in fluid connection with one another by way of a fluid channel in the first carrier part.

5. Valve according to claim 4, in which the second planar element has three second openings, wherein the valve elements are movable relative to one another in the at least one direction parallel to the abutment surface into at least two different first positions, in each of which two of the three second openings are in fluid connection with one another by way of the fluid channel in the first carrier part.

6. Valve according to claim 3, in which the first planar element has three first openings, wherein two of those openings are in fluid connection with one another by way of a fluid channel in the first carrier part, and the third of those openings is in fluid connection with the outside of the first valve element by way of a fluid channel in the first carrier part.

7. Valve according to claim 1, which comprises a third valve element, wherein
the third valve element comprises a third carrier part of plastics material and a third planar element of silicon or silicon oxide which is fastened to the third carrier part,
the second valve element comprises two second planar elements of silicon or silicon oxide which are fastened to the second carrier part,
the valve elements are so arranged that the first planar element and one of the second planar elements abut one another at least partially in a planar manner along a first abutment surface, and the third planar element and the other of the second planar elements abut one another at least partially in a planar manner along a second abutment surface, which is parallel to the first abutment surface,
the second valve element is movable relative to the first valve element and the third valve element in at least one direction parallel to the abutment surfaces of the planar elements,
the third planar element has at least one third opening, and
the second valve element is movable relative to the first and the third valve element in the at least one direction parallel to the abutment surfaces into at least one first position, in which the at least one first opening and the at least one third opening are in fluid connection with one another by way of the at least one second opening, and at least one second position, in which the at least one first opening and the at least one third opening are not in fluid connection with one another.

8. Valve according to claim 1, in which the first carrier part has a recess which is covered completely by the first planar element, wherein the first planar element has at least two first openings which are in fluid connection with one another by way of the recess.

9. Valve according to claim 1, in which the valve elements are movable relative to one another by rotation of one valve element relative to the other valve element or elements about an axis perpendicular to the abutment surface.

10. Valve according to claim 1, in which the valve elements are movable relative to one another by a parallel displacement of one valve element relative to the other valve element or elements.

11. Valve according to claim 1, in which the first planar element and/or the second planar element has a plurality of openings with different opening cross-sections so that, depending on the arrangement of the planar elements relative to one another, a flow of fluid through the valve can be adjusted by way of those different opening cross-sections.

12. Valve according to claim 1, which further comprises an actuator for moving the valve elements relative to one another, wherein the actuator is so constructed that it can be uncoupled from the remaining part of the valve.

13. Device for measuring the properties of a fluid, wherein the device comprises a valve according to claim 1 for controlling the transport of the fluid in the device.

14. Device according to claim 13, wherein the valve is a multiway valve, in which the first planar element has a plurality of first openings and/or the second planar element has a plurality of second openings, wherein the valve elements are movable relative to one another in the at least one direction parallel to the abutment surface into a plurality of different first positions, in each of which at least one of the first openings is in fluid connection with at least one of the second openings, wherein the device is so configured that, with the valve elements arranged in one of the plurality of first positions, a calibration fluid for calibrating the device can be transported through the valve and, with the valve elements arranged in another of the plurality of first positions, the fluid can be transported through the valve for measurement of the properties of the fluid in the device.

15. Use of the valve according to claim 2 in a device for measuring the properties of a fluid, wherein the use comprises the following steps:
movement of the valve elements of the valve relative to one another in the at least one direction parallel to the abutment surface into one of the plurality of first positions,
transport of a calibration fluid through the valve in order to calibrate the device while the valve elements are arranged in the one first position,
movement of the valve elements of the valve relative to one another in the at least one direction parallel to the abutment surface into another of the plurality of first positions, and
transport of the fluid through the valve in order to measure the properties of the fluid in the device while the valve elements are arranged in the other first position.

16. Micropump for pumping a fluid, which comprises a valve according to claim 1 for controlling the transport of the fluid in the micropump.

17. Micropump according to claim 16, wherein the valve is a multiway valve, in which the first planar element has a plurality of first openings and/or the second planar element has a plurality of second openings, wherein the valve elements are movable relative to one another in the at least one direction parallel to the abutment surface into a plurality of different first positions, in each of which at least one of the first openings is in fluid connection with at least one of the second openings, wherein the micropump is so configured that its pumping direction can be reversed by moving the valve elements of the valve relative to one another in the at least one direction parallel to the abutment surface from one of the plurality of first positions into another of the plurality of first positions.

18. Micropump according to claim 16, wherein the valve directly controls the transport of the fluid at the inlet and outlet of a pump chamber of the micropump.

19. Atomization system for producing an aerosol, having a valve according to claim 1 for controlling the transport of a fluid in the atomization system.

20. Metering/mixing device for metering and/or mixing a defined fluidic volume, which comprises a valve according to claim 1 for controlling the transport of a fluid in the metering/mixing device.
